(19) United States
(12) Patent Application Publication
(10) Pub. No.: US 2017/0242847 A1
(43) Pub. Date: Aug. 24, 2017

(54) APPARATUS AND METHOD FOR TRANSLATING A MEETING SPEECH

(71) Applicant: Kabushiki Kaisha Toshiba, Minato-ku (JP)

(72) Inventors: Hailiang LI, Beijing (CN); Xin LI, Beijing (CN); Lingzhu WANG, Beijing (CN)

(73) Assignee: Kabushiki Kaisha Toshiba, Minato-ku (JP)

(21) Appl. No.: 15/262,493

(22) Filed: Sep. 12, 2016

(30) Foreign Application Priority Data
Feb. 19, 2016 (CN) 201610094537.8

(51) Int. Cl. G06F 17/28; G10L 13/08; G06F 17/27

(52) U.S. Cl. CPC G06F 17/289; G06F 17/277; G10L 13/08

(57) ABSTRACT

According to one embodiment, a speech translation apparatus includes a speech recognition unit, a machine translation unit, an extracting unit, and a receiving unit. The extracting unit extracts words used for a meeting from a word set, based on information related to the meeting, and sends the extracted words to the speech recognition unit and the machine translation unit. The receiving unit receives the speech in a first language in the meeting. The speech recognition unit recognizes the speech in the first language as a text in the first language. The machine translation unit translates the text in the first language into a text in a second language.

### CROSS-REFERENCE TO RELATED APPLICATION

This application is based upon and claims the benefit of priority from Chinese Patent Application No. 201610094537.8, filed on Feb. 19, 2016; the entire contents of which are incorporated herein by reference.

### FIELD

The present invention relates to an apparatus and a method for translating a meeting speech.

### BACKGROUND

Meeting has become an important means for people to communicate in daily working and life. Moreover, with the globalization of culture and economy, meetings among people with different native languages are increasing, especially in most multinational corporations, multi-language meeting is very frequent, for example, people participating the meeting will communicate by using different native languages (e.g., Chinese, Japanese, English, etc).

For this reason, speech recognition and machine translation technology to provide speech translation service in a multi-language meeting also came into being. To improve recognition and translation accuracy of professional terminology, generally, a large number of word sets in different domains are collected in advance, and in the practical meeting, speech recognition and machine translation is conducted by using a word set in a domain related to this meeting.

However, when applied in a practical meeting, the above method of conducting translation by using a domain word set in prior art appears to have high cost and low efficiency. The effect is not obvious, due to the domain word set is huge and difficult to be dynamically updated.

Furthermore, in the practical meeting, according to a topic of the meeting and participants in the meeting, many different professional terminology or organizational words will be used in the meeting. This will lead to the deterioration of accuracy of speech recognition and machine translation, thus affecting quality of meeting speech translation service.

### BRIEF DESCRIPTION OF THE DRAWINGS

FIG. 1 is a schematic flowchart of a method for translating a meeting speech according to one embodiment.

FIG. 2 is a schematic flowchart of filtering the extracted words in the method for translating a meeting speech according to one embodiment.

FIG. 3 is another schematic flowchart of filtering the extracted words in the method for translating a meeting speech according to one embodiment.

FIG. 4 is still another schematic flowchart of filtering the extracted words in the method for translating a meeting speech according to one embodiment.

FIG. 5 is a schematic flowchart of updating usage frequency of the accumulated user words in the method for translating a meeting speech according to one embodiment.

FIG. 6 is a schematic flowchart of adding group words in the method for translating a meeting speech according to one embodiment.

FIG. 7 is a block diagram of an apparatus for translating a meeting speech according to another embodiment.

### DETAILED DESCRIPTION

According to one embodiment, a speech translation apparatus includes a speech recognition unit, a machine translation unit, an extracting unit, and a receiving unit. The extracting unit extracts words used for a meeting from a word set, based on information related to the meeting, and sends the extracted words to the speech recognition unit and the machine translation unit. The receiving unit receives the speech in a first language in the meeting. The speech recognition unit recognizes the speech in the first language as a text in the first language. The machine translation unit translates the text in the first language into a text in a second language.

Below, various preferred embodiments of the invention will be described in detail with reference to drawings.

<A Method for Translating a Meeting Speech>

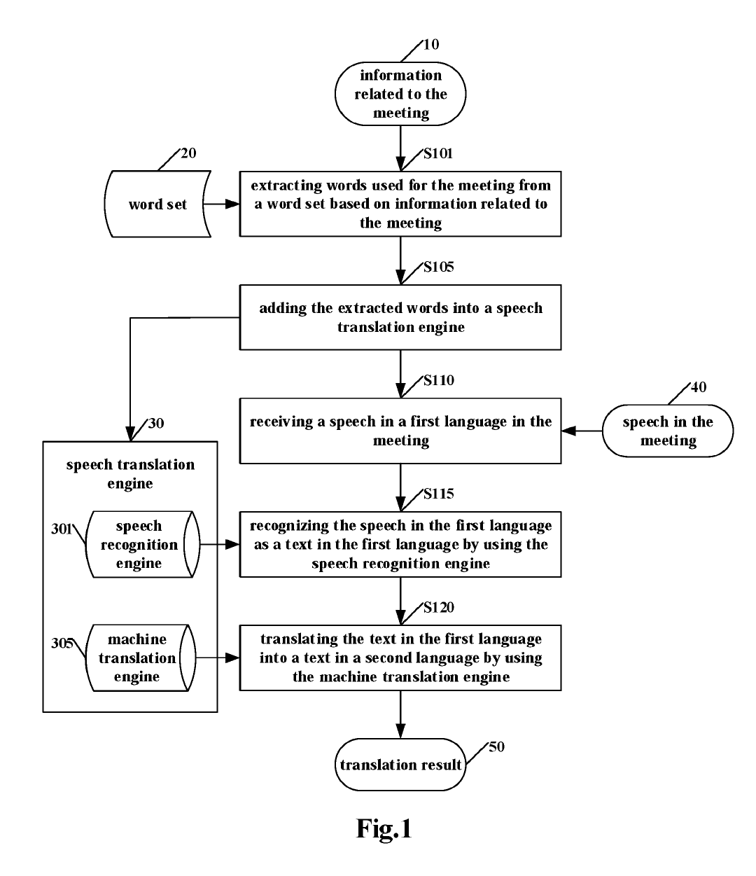

FIG. 1 is a schematic flowchart of a method for translating a meeting speech according to an embodiment of the invention.

As shown in FIG. 1, this embodiment provides a method for translating a meeting speech, comprising: step S101, words used for the meeting are extracted from a word set 20 based on information 10 related to the meeting; step S105, the extracted words are added into a speech translation engine 30 including a speech recognition engine 301 and a machine translation engine 305; step S110, a speech in a first language in the meeting is received from the speech 40 in the meeting; step S115, the speech in the first language is recognized as a text in the first language by using the speech recognition engine 301; and step S120, the text in the first language is translated into a text in a second language by using the machine translation engine 305.

In this embodiment, a meeting refers to a meeting in broad sense, including a meeting attended by at least two parties (or two people), or including a lecture or report made by at least one people toward more than one people, even including speech or video chatting among more than two people, that is, it belongs to the meeting here as long as there are more than two people communicating via speech.

In this embodiment, the meeting may be an on-site meeting, such as a meeting held in a meeting room in which meeting attendees communicate with other meeting attendees directly, and may also be a network conference, that is, people attend in the meeting via a network and in this case, the speech of a meeting attendee may be communicated to other meeting attendees through the network.

Various steps of the method for translating a meeting speech of this embodiment will be described in detail below.

In step S101, words used for the meeting are extracted from a word set 20 based on information 10 related to the meeting.

In this embodiment, the information 10 related to the meeting preferably includes a topic of the meeting and user information, the user information is information of meeting attendee(s).

The word set 20 preferably includes a user lexicon, a group lexicon and relationship information between a user and a group. The word set 20 includes therein a plurality of user lexicons, each of which includes words related to that user, for example, words of that user accumulated in historical meetings, words specific to that user, etc. A plurality of users are grouped in the word set 20, each group has a group lexicon. Each word in a lexicon includes a source text, a pronunciation of the source text and a translation of the source text, wherein the translation may include translation in multiple languages.

In this embodiment, preferably, words used for this meeting are extracted from the word set 20 through the following method.

First, user words related to the user are extracted from the user lexicon in the word set 20 based on the user information, and group words of a group to which the user belongs are extracted from the group lexicon based on the relationship information between the user and the group.

Next, after extracting the user words and the group words, preferably, words related to the meeting are extracted from the extracted user words and the extracted group words based on the topic of the meeting.

Moreover, preferably, the extracted words related to the meeting are filtered, and preferably, words that are the same and words with low usage frequency are filtered out.

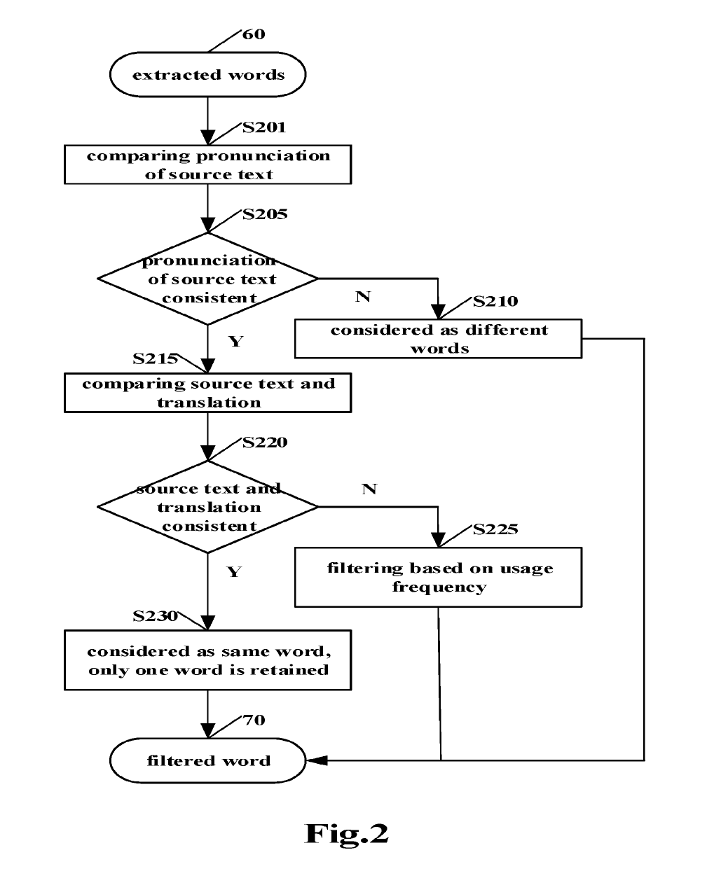

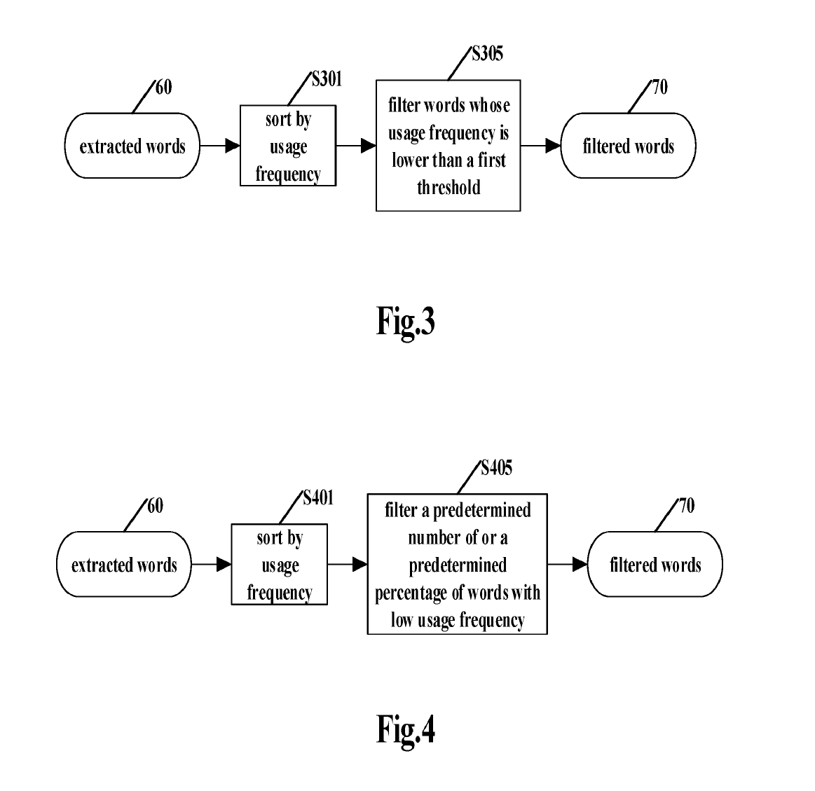

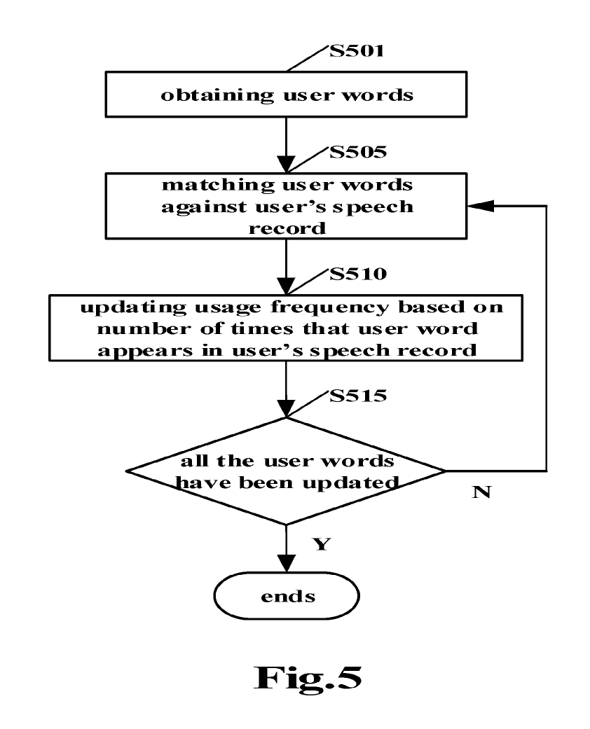

Next, preferred methods of filtering the extracted user words and group words in this embodiment will be described in detail with reference to FIGS. 2 to 4. FIG. 2 is a schematic flowchart of filtering the extracted words in the method for translating a meeting speech according to an embodiment of the invention. FIG. 3 is another schematic flowchart of filtering the extracted words in the method for translating a meeting speech according to an embodiment of the invention. FIG. 4 is still another schematic flowchart of filtering the extracted words in the method for translating a meeting speech according to an embodiment of the invention.

As shown in FIG. 2, in step S201, the pronunciation of the source text of the extracted words 60 is compared, in step S205, it is determined whether the pronunciation of the source text is consistent. The extracted words are considered as different words in case that the pronunciation information of the source text is inconsistent.

In case that the pronunciation of the source text is consistent, in step S215, the source text and the translation of the words whose pronunciation of the source text are consistent are compared. In step S220, it is determined whether the source text and the translation are consistent, in case that pronunciation of the source text is consistent but the source text and the translation are inconsistent, in step S225, the filtering is performed based on a usage frequency.

For a user word, its usage frequency may be, for example, the number of times it was used by a user in historical speech, and for a group word, its usage frequency may be, for example, the number of times it was used by a user belongs to that group in historical speech. In step S225, words whose usage frequency is lower than a certain threshold are filtered out. Moreover, in step S225, it may also be that words matching a topic of the meeting and having the highest usage frequency are retained, and other words are filtered out.

In step S230, in case that pronunciation of the source text, the source text and the translation are all consistent, words are considered as a same word and only one word will be retained, while other same words will be filtered out.

Moreover, the extracted words 60 may also be filtered based on the method of FIG. 3 or FIG. 4, or after being filtered based on the method of FIG. 2, the words may be filtered again based on the method of FIG. 3 or FIG. 4. That is, the filtering methods of FIG. 2, FIG. 3 and FIG. 4 may be used solely or in any combination thereof.

The absolute filtering method of FIG. 3 and the relative filtering method of FIG. 4 will be described below in detail.

As shown in FIG. 3, in step S301, the extracted words 60 are sorted by usage frequency in descending order. Next, in step S305, words whose usage frequency is lower than a certain threshold are filtered out.

As shown in FIG. 4, in step S401, the extracted words 60 are sorted by usage frequency in descending order. Next, in step S405, a predetermined number of or a predetermined percentage of words with low usage frequency are filtered out, for example, 1000 words with low usage frequency are filtered out, or 30% of words with low usage frequency are filtered out.

Returning to FIG. 1, in step S105, the extracted words are added into a speech translation engine 30. The speech translation engine 30 includes a speech recognition engine 301 and a machine translation engine 305, which may be any speech recognition engine and machine translation engine known to those skilled in the art, and this embodiment has no limitation thereon.

In step S110, a speech in a first language in the meeting is received from the speech 40 in the meeting.

In this embodiment, the first language may be any one of human languages, such as English, Chinese, Japanese, etc., and the speech in the first language may be spoken by a person and may also be spoken by a machine, such as a record played by a meeting attendee, and this embodiment has no limitation on it.

In step S115, the speech in the first language is recognized as a text in the first language by using the speech recognition engine 301. In step S120, the text in the first language is translated into a text in a second language by using the machine translation engine 305.

In this embodiment, the second language may be any language that is different from the first language.

Through the method for translating a meeting speech of this embodiment, adaptive data which is only suitable for this meeting is extracted based on basic information of the meeting, and registered to a speech translation engine in real-time, which has small data amount, low cost and high efficiency, and is able to provide speech translation service with high quality. Further, through the method for translating a meeting speech of this embodiment, words which are only suitable for this meeting are extracted from a word set based on a topic of the meeting and user information, which have small data amount, low cost and high efficiency, and are able to improve quality of meeting speech translation. Further, through the method for translating a meeting speech of this embodiment, it is able to further reduce data amount, reduce cost and improve efficiency by filtering the extracted words.

Moreover, preferably, in the method for translating a meeting speech of this embodiment, new user words are accumulated based on the user's speech in the meeting, and the new user words are added into the speech translation engine 30.

Moreover, still preferably, in the method for translating a meeting speech of this embodiment, new user words are accumulated based on the user's speech in the meeting, and the new user words are added into the user lexicon of the word set 20.

Next, the method of accumulating new user words in this embodiment will be described in detail.

In this embodiment, the method of accumulating new user words based on the user's speech in the meeting may be any one of or combination of the following methods of:
(1) manually inputting a source text of the new user words, a pronunciation of the source text and a translation of the source text, based on the user's speech in the meeting.
(2) manually inputting a source text of the new user words based on the user's speech in the meeting, generating a pronunciation of the source text by using a Grapheme-to-Phoneme module and/or a Text-to-Phoneme module, and generating a translation of the source text by using a machine translation engine, wherein the automatically generated information may be modified.
(3) collecting voice data from the user's speech in the meeting, generating a source text and a pronunciation of the source text by using the speech recognition engine, and generating a translation of the source text by using the machine translation engine, wherein the automatically generated information may be modified.
(4) selecting the user words to be recorded from the speech recognition result and the machine translation result of the meeting, preferably, the recordation is made after proofreading.
(5) detecting unknown words in the speech recognition result and the machine translation result of the meeting, preferably, the recordation is made after proofreading.

It is appreciated that, although new user words may be accumulated based on the above preferred methods, other methods of accumulating new user words known to those skilled in the art may also be used, and this embodiment has no limitation thereon.

Moreover, during the process of accumulating new user words based on the user's speech in the meeting, topic information of the meeting and user information related to the new user are also obtained.

Moreover, in this embodiment, after adding the accumulated new user words into the user lexicon of the word set 20, usage frequency of the user words are preferably updated in real-time or in the future.

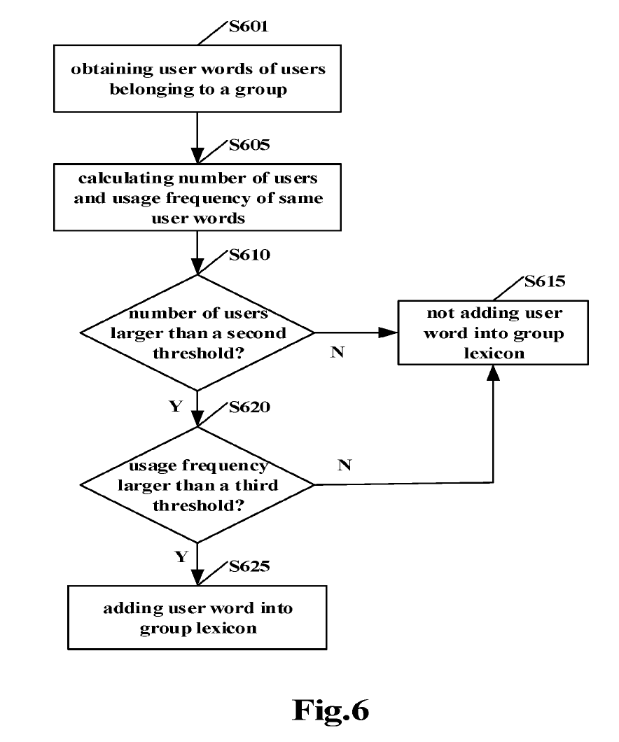

Next, a method of updating usage frequency of user words will be described in detail with reference to FIG. 5. FIG. 5 is a schematic flowchart of a method of updating usage frequency of the accumulated user words in the method for translating a meeting speech according to an embodiment of the invention.

As shown in FIG. 5, in step S501, user words are obtained. Next, in step S505, the user words are matched against the user's speech record, that is, for a user word, it is looked up in the user's speech record to see whether that user word exists. If that user word exists, then in step S510, the number of times a match occurs, that is, the number of times that user word appears in the user's speech record, is updated into a database as use frequency of that user word. Next, in step S515, it is judged whether all the user words have been matched, if there is no more user word, the process ends, otherwise, the process returns to step S505 to continue to perform matching.

Moreover, preferably, in the method for translating a meeting speech of this embodiment, new group words are added into the group lexicon of the word set 20 based on the user words.

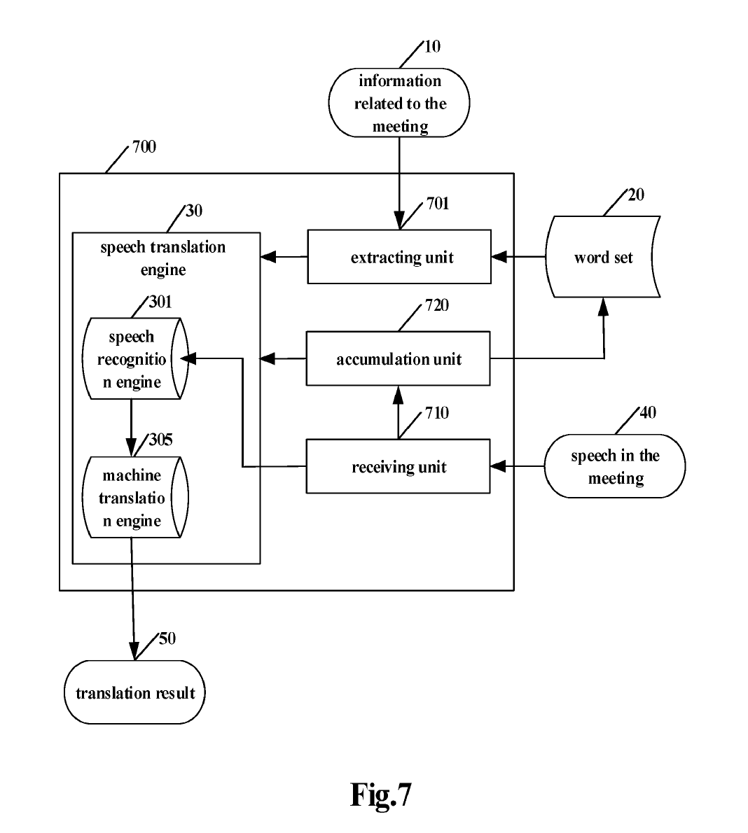

Next, a method of adding new group words into a group lexicon will be described in detail with reference to FIG. 6. FIG. 6 is a schematic flowchart of a method of adding group words in the method for translating a meeting speech according to an embodiment of the invention.

As shown in FIG. 6, in step S601, user words of users belonging to a group are obtained.

In step S605, number of users and usage frequency of same user words are calculated. Specifically, attribute information of each user word includes user information and usage frequency, the number of user lexicons containing that user word is taken as the number of users, and the sum of usage frequency of that user word in each user lexicon is taken as the usage frequency calculated in step S605.

Next, it is compared in step S610 whether the number of users is greater than a second threshold, and it is compared in step S620 whether the usage frequency is greater than a third threshold. In case that the number of users is greater than the second threshold and the usage frequency is greater than the third threshold, that user word is added into the group lexicon as a group word in step S625; in case that the number of users is not greater than the second threshold or the usage frequency is not greater than the third threshold, that user word is not added into the group lexicon as a group word in step S615.

Through the method for translating a meeting speech of this embodiment, by accumulating new words during the meeting and automatically updating a speech translation engine, the speech translation engine can be automatically regulated according to content of speech during the meeting, so as to achieve dynamic adaptive speech translation effect. Moreover, through the method for translating a meeting speech of this embodiment, by accumulating new words during the meeting, the new words are added into a word set and the new words are applied in future meeting, which is able to constantly improve quality of meeting speech translation.

<An Apparatus for Translating a Meeting Speech>

Under a same inventive concept, FIG. 7 is a block diagram of an apparatus for translating a meeting speech according to another embodiment of the invention. Next, this embodiment will be described in conjunction with that figure, and for those parts same as the above embodiment, the description of which will be properly omitted.

As shown in FIG. 7, this embodiment provides an apparatus 700 for translating a meeting speech, comprising: a speech translation engine 30 including a speech recognition engine 301 and a machine translation engine 305; an extracting unit 701 configured to extract words used for the meeting from a word set 20 based on information 10 related to the meeting, and add the extracted words into the speech translation engine 30; and a receiving unit 710 configured to receive a speech in a first language in the meeting; wherein, the speech recognition engine 301 is configured to recognize the speech in the first language as a text in the first language, and the machine translation engine 305 is configured to translate the text in the first language into a text in a second language. Moreover, optionally, the apparatus 700 for translating a meeting speech of this embodiment may further comprise an accumulation unit 720.

In this embodiment, a meeting refers to a meeting in broad sense, including a meeting attended by at least two parties (or two people), or including a lecture or report made by at least one people toward more than one people, even including speech or video chatting among more than two people, that is, it belongs to the meeting here as long as there are more than two people communicating via speech.

In this embodiment, the meeting may be an on-site meeting, such as a meeting held in a meeting room in which meeting attendees communicate with other meeting attendees directly, and may also be a network conference, that is, people attend in the meeting via a network and in this case, the speech of a meeting attendee may be communicated to other meeting attendees through the network.

Various units and modules of the apparatus 700 for translating a meeting speech of this embodiment will be described in detail below.

The extracting unit 701 is configured to extract words used for the meeting from a word set 20 based on information 10 related to the meeting.

In this embodiment, the information 10 related to the meeting preferably includes a topic of the meeting and user information, the user information is information of meeting attendee(s).

The word set 20 preferably includes a user lexicon, a group lexicon and relationship information between a user and a group. The word set 20 includes therein a plurality of user lexicons, each of which includes words related to that user, for example, words of that user accumulated in historical meetings, words specific to that user, etc. A plurality of users are grouped in the word set 20, each group has a group lexicon. Each word in a lexicon includes a source text, a pronunciation of the source text and a translation of the source text, wherein the translation may include translation in multiple languages.

In this embodiment, the extracting unit 701 is configured to extract words used for this meeting from the word set 20 through the following method.

First, the extracting unit 701 is configured to extract user words related to the user from the user lexicon in the word set 20 based on the user information, and extract group words of a group to which the user belongs from the group lexicon based on the relationship information between the user and the group.

Next, the extracting unit 701 is configured to, after extracting the user words and the group words, extract words related to the meeting from the extracted user words and the extracted group words based on the topic of the meeting.

Moreover, preferably, the extracting unit 701 includes a filtering unit. The filtering unit is configured to filter the extracted words related to the meeting, and preferably, filter out words that are the same and words with low usage frequency.

In this embodiment, the method of filtering the extracted words related to the meeting used by the filtering unit is similar to that described above with reference to FIGS. 2 to 4. Next, the description will be made with reference to FIGS. 2 to 4.

As shown in FIG. 2, the filtering unit is configured to first compare the pronunciation of the source text of the extracted words 60, determine whether the pronunciation of the source text is consistent. The extracted words are considered as different words in case that the pronunciation information of the source text is inconsistent.

In case that the pronunciation of the source text is consistent, the filtering unit is configured to compare the source text and the translation of the words whose pronunciation of the source text are consistent, determine whether the source text and the translation are consistent, in case that the pronunciation of the source text is consistent but the source text and the translation are inconsistent, the filtering unit is configured to perform filtering based on a usage frequency.

For a user word, its usage frequency may be, for example, the number of times it was used by a user in historical speech, and for a group word, its usage frequency may be, for example, the number of times it was used by a user belongs to that group in historical speech. The filtering unit is configured to filter out words whose usage frequency is lower than a certain threshold. Moreover, the filtering unit is also configured to retain words matching a topic of the meeting and having the highest usage frequency, and to filter out other words.

Moreover, the filtering unit is configured to, in case that pronunciation of the source text, the source text and the translation are all consistent, retain only one word for words that are considered as a same word, and filter out other same words.

Moreover, the filtering unit is also configured to filter the extracted words 60 based on the method of FIG. 3 or FIG. 4, or after being filtered based on the method of FIG. 2, the words may be filtered again based on the method of FIG. 3 or FIG. 4. That is, the filtering methods of FIG. 2, FIG. 3 and FIG. 4 may be used solely or in any combination thereof.

The absolute filtering method of FIG. 3 and the relative filtering method of FIG. 4 will be described below in detail.

As shown in FIG. 3, the filtering unit is configured to sort the extracted words 60 by usage frequency in descending order. Next, the filtering unit is configured to filter out words whose usage frequency is lower than a certain threshold.

As shown in FIG. 4, the filtering unit is configured to sort the extracted words 60 by usage frequency in descending order. Next, the filtering unit is configured to filter a predetermined number of or a predetermined percentage of words with low usage frequency, for example, to filter out 1000 words with low usage frequency, or filter out 30% of words with low usage frequency.

Returning to FIG. 7, the extracting unit 701 is configured to, after words related the meeting have been extracted, add the extracted words into a speech translation engine 30. The speech translation engine 30 includes a speech recognition engine 301 and a machine translation engine 305, which may be any speech recognition engine and machine translation engine known to those skilled in the art, and this embodiment has no limitation thereon.

The receiving unit 710 is configured to receive a speech in a first language in the meeting from the speech 40 in the meeting.

In this embodiment, the first language may be any one of human languages, such as English, Chinese, Japanese, etc., and the speech in the first language may be spoken by a person and may also be spoken by a machine, such as a record played by a meeting attendee, and this embodiment has no limitation on it.

The receiving unit 710 is configured to input the received speech in the first language into the speech recognition engine 301, which recognizes the speech in the first language as a text in the first language, then, the machine translation engine 305 translates the text in the first language into a text in a second language.

In this embodiment, the second language may be any language that is different from the first language.

Through the apparatus 700 for translating a meeting speech of this embodiment, adaptive data which is only suitable for this meeting is extracted based on basic information of the meeting, and registered to a speech translation engine in real-time, which has small data amount, low cost and high efficiency, and is able to provide speech translation service with high quality. Further, through the apparatus for translating a meeting speech of this embodiment, words which are only suitable for this meeting are extracted from a word set based on a topic of the meeting and user information, which have small data amount, low cost and high efficiency, and are able to improve quality of meeting speech translation. Further, through the apparatus for translating a meeting speech of this embodiment, it is able to further reduce data amount, reduce cost and improve efficiency by filtering the extracted words.

Moreover, preferably, the apparatus 700 for translating a meeting speech of this embodiment comprises an accumulation unit 720 configured to accumulate new user words based on the user's speech in the meeting, and add the new user words into the speech translation engine 30.

Moreover, the accumulation unit 720 is preferably configured to accumulate new user words based on the user's speech in the meeting, and add the new user words into the user lexicon of the word set 20.

Next, the function of accumulating new user words of the accumulation unit 720 in this embodiment will be described in detail.

In this embodiment, the accumulation unit 720 has at least one of the following functions of:
(1) manually inputting a source text of the new user words, a pronunciation of the source text and a translation of the source text, based on the user's speech in the meeting.
(2) manually inputting a source text of the new user words based on the user's speech in the meeting, generating a pronunciation of the source text by using a Grapheme-to-Phoneme module and/or a Text-to-Phoneme module, and generating a translation of the source text by using a machine translation engine, wherein the automatically generated information may be modified.
(3) collecting voice data from the user's speech in the meeting, generating a source text and a pronunciation of the source text by using the speech recognition engine, and generating a translation of the source text by using the machine translation engine, wherein the automatically generated information may be modified.
(4) selecting the user words to be recorded from the speech recognition result and the machine translation result of the meeting, preferably, the recordation is made after proofreading.
(5) detecting unknown words in the speech recognition result and the machine translation result of the meeting, preferably, the recordation is made after proofreading.

It is appreciated that, in addition to the above functions, the accumulation unit 720 may also has other functions of accumulating new user words known to those skilled in the art, and this embodiment has no limitation thereon.

Moreover, the accumulation unit 720 is configured to, during the process of accumulating new user words based on the user's speech in the meeting, also obtain topic information of the meeting and user information related to the new user.

Moreover, the apparatus 700 for translating a meeting speech of this embodiment preferably further comprises an updating unit configured to, after the accumulated new user words are added into the user lexicon of the word set 20 by the accumulation unit 720, update usage frequency of the user words in real-time or in the future.

In this embodiment, the method of updating usage frequency of user words by the updating unit is similar to that described with reference to FIG. 5, which will be described here with reference to FIG. 5.

As shown in FIG. 5, the updating unit is configured to obtain user words. Next, the updating unit is configured to match the user words against the user's speech record, that is, for a user word, it is looked up in the user's speech record to see whether that user word exists. If that user word exists, then the updating unit is configured to update the number of times a match occurs, that is, the number of times that user word appears in the user's speech record, into a database as use frequency of that user word. Finally, the updating unit is configured to judge whether all the user words have been matched, if there is no more user word, the process ends, otherwise, the process continues to perform matching.

Moreover, the apparatus 700 for translating a meeting speech of this embodiment preferably further comprises a group word adding unit configured to add new group words into the group lexicon of the word set 20 based on the user words.

In this embodiment, the method of adding new group words into the group lexicon of the group word adding unit is similar to that described with reference to FIG. 6, which will be described here with reference to FIG. 6.

As shown in FIG. 6, the group word adding unit is configured to obtain user words of users belonging to a group.

The group word adding unit is configured to calculate number of users and usage frequency of same user words. Specifically, attribute information of each user word includes user information and usage frequency, the number of user lexicons containing that user word is taken as the number of users, and the sum of usage frequency of that user word in each user lexicon is taken as the usage frequency.

The group word adding unit is configured to compare whether the number of users is greater than a second threshold, and compare whether the usage frequency is greater than a third threshold. In case that the number of users is greater than the second threshold and the usage frequency is greater than the third threshold, that user word is added into the group lexicon as a group word; in case that the number of users is not greater than the second threshold or the usage frequency is not greater than the third threshold, that user word is not added into the group lexicon as a group word.

Through the apparatus 700 for translating a meeting speech of this embodiment, by accumulating new words during the meeting and automatically updating a speech translation engine, the speech translation engine can be automatically regulated according to content of speech during the meeting, so as to achieve dynamic adaptive speech translation effect. Moreover, through the apparatus for translating a meeting speech of this embodiment, by accumulating new words during the meeting, the new words are added into a word set and the new words are applied in future meeting, which is able to constantly improve quality of meeting speech translation.

Although a method and apparatus for translating a meeting speech of the present invention have been described in detail through some exemplary embodiments, the above embodiments are not to be exhaustive, and various variations and modifications may be made by those skilled in the art within spirit and scope of the present invention. Therefore, the present invention is not limited to these embodiments, and the scope of which is only defined in the accompany claims.

What is claimed is:

1. An apparatus for translating a speech, comprising:
a speech recognition unit;
a machine translation unit;
an extracting unit that extracts words used for a meeting from a word set, based on information related to the meeting, and sends the extracted words to the speech recognition unit and the machine translation unit; and
a receiving unit that receives the speech in a first language in the meeting;
the speech recognition unit recognizes the speech in the first language as a text in the first language, the machine translation unit translates the text in the first language into a text in a second language.

2. The apparatus according to claim 1, wherein
the information related to the meeting includes a topic of a meeting and user information,
the word set includes a user lexicon, a group lexicon and relationship information between a user and a group, and
the extracting unit
extracts user words related to the user from the user lexicon, based on the user information,
extracts group words of a group to which the user belongs from the group lexicon, based on the relationship information between the user and the group, and
extracts words related to the meeting from the extracted user words and the extracted group words, based on the topic of the meeting.

3. The apparatus according to claim 2, wherein
the extracting unit further comprises:
a filtering unit that filters the extracted words, based on a relationship among a source text of the words, a pronunciation of the source text and a translation of the source text.

4. The apparatus according to claim 3, wherein
the filtering unit
compares whether the pronunciation of the source text of the words are consistent,
compares whether the source text and the translation are consistent in case that the pronunciation of the source text are consistent,
filters the words whose pronunciation of the source text, the source text and the translation are all consistent in case that the source text and the translation are consistent, and
filters the words whose pronunciation of the source text are consistent based on a usage frequency of the words, in case that at least one of the source text and the translation is not consistent.

5. The apparatus according to claim 4, wherein
the filtering unit
sorts the extracted words by the usage frequency, and
filters out the words whose usage frequency is lower than a first threshold, or
filters out the words whose predetermined number of or predetermined percentage of words with low usage frequency.

6. The apparatus according to claim 1, further comprising:
an accumulation unit that accumulates new user words based on the user's speech in the meeting, and sends the new user words to the speech recognition unit and the machine translation unit.

7. The apparatus according to claim 1, further comprising:
an accumulation unit that accumulates new user words based on the user's speech in the meeting, and adds the new user words into the user lexicon of the word set;
wherein the new user words include a topic of the meeting and user information.

8. The apparatus according to claim 6, wherein
the accumulation unit has at least one of the functions of;
manually inputting a source text of the new user words, a pronunciation of the source text and a translation of the source text;
manually inputting a source text of the new user words, generating a pronunciation of the source text by using a Text-to-Phoneme module, and generating a translation of the source text by using the machine translation unit;
collecting voice data from the user's speech in the meeting, generating a source text and a pronunciation of the source text by using the speech recognition unit, and generating a translation of the source text by using the machine translation unit;
selecting the new user words from the speech recognition result and the machine translation result of the meeting; and
detecting unknown words in the speech recognition result and the machine translation result of the meeting as the new user words.

9. The apparatus according to claim 7, further comprising:
an updating unit that updates a usage frequency of user words of the user lexicon.

10. The apparatus according to claim 7, further comprising:
a group word adding unit that adds new group words into the group lexicon of the word set based on user words;
wherein the group word adding unit
obtains user words of users belonging to the group,
calculates a number of users and a usage frequency of same user words, and
adds the user words whose number of users is larger than a second threshold and/or whose usage frequency is larger than a third threshold into the group lexicon as group words.

11. A method for translating a speech, comprising:
extracting words used for a meeting from a word set, based on information related to the meeting;
sending the extracted words to a speech recognition unit and a machine translation unit;
receiving a speech in a first language in the meeting;
recognizing the speech in the first language as a text in the first language by using the speech recognition unit; and
translating the text in the first language into a text in a second language by using the machine translation unit.
